(19) United States
(12) Patent Application Publication
(10) Pub. No.: US 2020/0334995 A1
(43) Pub. Date: Oct. 22, 2020

(54) DISTRIBUTED REGISTERS FOR THE MANAGEMENT OF WEATHER DATA IN AERONAUTICS

(71) Applicant: THALES, COURBEVOIE (FR)

(72) Inventor: Guillaume PABIA, MERIGNAC (FR)

(21) Appl. No.: 16/843,793

(22) Filed: Apr. 8, 2020

(30) Foreign Application Priority Data
Apr. 19, 2019 (FR) 1904183

(51) Int. Cl. G08G 5/00; G01W 1/08; B64C 39/02; H04L 9/06; G06N 20/00

(52) U.S. Cl. CPC G08G 5/0091; G08G 5/0043; G08G 5/0021; G01W 1/08; H04L 2209/56; H04L 9/0643; G06N 20/00; B64C 2201/125; H04L 2209/38; B64C 39/024

(57) ABSTRACT

Systems and methods implemented by computer for the sharing of weather data are provided, a method notably includes the steps of collecting data during aircraft flights, receiving data relating to the trajectory of a client aircraft; based on said trajectory, selecting relevant weather data in a shared weather database comprising the collected weather data; in response to a request from the client aircraft, communicating the weather data selected according to an exchange control mechanism. Developments describe a weather data exchange control mechanism using smart contracts, the use of confidence scores, computations of correlation between meteorology declared and measured in flight, the use of drones as probes, the use of open sources, of machine learning, of management of time-based and/or space-based validity of the weather data.

### CROSS-REFERENCE TO RELATED APPLICATIONS

This application claims priority to foreign French patent application No. FR 1904183, filed on Apr. 19, 2019, the disclosure of which is incorporated by reference in its entirety.

### FIELD OF THE INVENTION

The document relates generally to the technical field of information processing. In particular, the document describes systems and methods for managing weather data in aeronautics, notably by using distributed databases.

### BACKGROUND

In the complex avionics ecosystem, the management of weather data (sometimes denoted Wx hereinbelow) raises numerous technical issues.

In particular, the sharing of weather information constitutes a critical problem. More specifically, how can the sharing of weather information possibly be optimized, while ensuring the integrity of the information transmitted to a pilot in flight, while relying on various sources of weather data?

Currently, the non-critical weather information is shared with the pilots of one and the same company. The different airlines generally do not want to share their information with other companies. Moreover, in some areas, it may be that the sources of weather data are not very reliable, if they exist at all. Finally, it may be that the weather conditions announced before the flight turn out to be different from those encountered by the pilot.

Generally, the sharing of data between industrial actors of one and the same business is always an issue, in which cooperation and competition become confused. Motivations to share the data often collide with impulses to form a private corpus, for exclusive purposes. Independently of the strategies of the industrial actors, fundamentally, to extract data of value, it remains advantageous to accumulate large quantities of data (e.g. sections, correlations, learning, etc.).

Theoretically, in order to improve this sharing of weather data, it would be advantageous to rely on a plurality of sources supplying weather data, which would then be shared with several clients.

In practice, a number of obstacles arise. The use of weather data sources from the “open world” (e.g. Internet), or else of measurement instruments belonging to third-party companies, poses the general question of data integrity. How in fact can there be an assurance that the weather information transmitted is correct? Erroneous—even malicious—data may in fact be injected, pointlessly delaying or falsifying the trajectories of the flights, leading to excess fuel consumptions, etc.

The patent document US20180074189 describes a subdivision of the space in voxels, then determines the best source of weather data for each voxel. Each item of weather information is therefore assigned a reliability index. This document does not teach how the data are communicated to an aircraft, and does not consider the origin of the data. This approach presents limitations and does not resolve the technical problems described previously.

The patent document EP3367137 describes a system for sharing critical weather information between several aircraft. A ground centre (intermediary) is responsible for managing the requests between the different airplanes (clients and suppliers). This solution is satisfactory in some situations but does present limitations with respect to wider cooperation. For example, the examples described provide for the presence of an intermediate, which is therefore added to the already complex ecosystem of aeronautics. Moreover, the transfer of information is performed only between airplanes; it notably does not rely on resources (nevertheless much more numerous) from the “open world” (i.e. beyond the regulatory framework, e.g. Internet data). The type of database used is not explained. Only the weather information is considered critical. The flight optimization information is for example not considered, even though this information can be of great “value”.

There is a need for advanced systems and methods for sharing and management of weather data in aeronautics.

### SUMMARY OF THE INVENTION

The document describes systems and methods implemented by computer for the sharing of weather data, a method notably comprising the steps of collecting data during aircraft flights, receiving data relating to a trajectory of a client aircraft; based on said trajectory, selecting relevant weather data in a shared weather database comprising the collected weather data; in response to a request from the client aircraft, communicating the weather data selected according to an exchange control mechanism. Developments describe a weather data exchange control mechanism using smart contracts, the use of confidence scores, computations of correlation between meteorology declared and measured in flight, the use of drones as probes, the use of open sources, of machine learning, of management of the time-based and/or space-based validity of the weather data.

To sum up, the invention is a system which allows for the sharing of information between several types of actors, whether they belong to the avionics/aviation world (A/C for aircraft, ATC for air traffic control, airport) or else to the so-called “open” world (any type of open or unregulated source, e.g. Internet).

The weather information can be stored in a conventional database, but each actor contributing to this base is assigned a score relating to its level of trust, based on the quality of its contributions. It is through the use of a DLT (“Distributed Ledger Technology”) or “block chain” that the information concerning the contributors is stored. Furthermore, according to the invention, a reward mechanism can be implemented to determine and encourage the best contributors. This shared information can then be communicated to the aircraft which are affected by the shared weather information.

In one embodiment, one or more block chains are used to store and share the weather data, therefore ensuring the quality thereof (e.g. timestamping, integrity, consensus-based validation, etc.). Optionally, the sharing of these data (e.g. transactions) is managed (or permitted or controlled) by one or more smart contracts (e.g. access to the data by the users, management of rights, etc.).

Advantageously, the authenticity and the integrity of the data handled are guaranteed through the use of a block chain.

Advantageously, the exchanges (or contributions) can be monitored, entered and tracked clearly and transparently, in such a way that the incentives to share are reinforced. Advantageously, the sharing of weather information is encouraged, by construction, in addition to being secured.

Advantageously, the network of contributors can be extended to so-called “open world” sources, and this can be done without having to manage the problems of integrity, of trust or of validity of the data. New, complementary, additional, recent, or otherwise enriched weather data can thus be handled.

Advantageously, the invention makes it possible to increase the capture of data, and thereby the quality of analyses derived therefrom (“analytics”). From suboptimal exchanges, the invention allows for fluid and transparent exchange between actors, in which the incentives to share are improved, the shares being rewarded and the parties being scored transparently if not predictably.

Advantageously, the application of artificial intelligence technologies (essentially machine learning) coupled with the massive deployment of connectivity between the aircrafts and/or the ground allows for massive and deep analyses (so-called “Big Data” approach), for advantageous and various purposes, e.g. estimation of fuel consumptions, optimization of trajectories, anticipation of weather to be passed through, improved safety and/or dependability of the flights, etc.

By specifically (i.e. appropriate with respect to the specific problems of aeronautics) incorporating the technologies relating to block chains and to smart contracts, the methods and systems according to the invention ultimately make it possible to improve aeronautical reliability. This reliability is fundamental in this industry. The existing aeronautical architectures are very closed (there are few links that exist between systems, because of the fear of data corruptions, of attacks, of systemic risks, etc.); the solution proposed can significantly enhance the technical management of inter-system data, by increasing the areas of analysis (quantity of data) and the quality of the analyses conducted.

### BRIEF DESCRIPTION OF THE DRAWINGS

Other features and advantages of the invention will become apparent from the following description and from the figures of the attached drawings in which:

FIG. 1 illustrates the operation of a block chain;

FIG. 2 illustrates an embodiment of the invention;

FIG. 3 illustrates an embodiment of the invention;

FIG. 4 illustrates examples of steps of an embodiment of the method according to the invention.

### DETAILED DESCRIPTION

### Weather Data

In avionics, the weather data can be classified in a number of categories: i) so-called “regulatory” or “normative” meteorology on the one hand, ii) the so-called “informative” or “strategic” weather data and iii) the “radar” weather data, measured by embedded devices.

Regarding the so-called regulatory meteorology, the weather observations and forecasts are incorporated in a regulatory weather file called “briefing” which is supplied to the pilot before the airplane takes off. This regulatory weather information is limited. The form and format is basic (text code and black and white graphics) and the data are generally valid only for a restricted time interval (of the order of three to six hours). This inevitable obsolescence of the weather data leads to significant complications and notably certain risks for flight safety.

Regarding the so-called “informative” or “forecast” or “strategic” weather data, the data of this type are generally presented in the form of graph data. They have the particular feature of complementing the regulatory data necessary to the operation of the flight. The purpose of the forecast or informative weather data is to give strategic level advice information, in places where the weather data radar does not have sufficient range and where the “briefing” information is no longer up to date.

Regarding radar meteorology, its range is limited by the measurement devices (i.e. short distance). It is used directly for the piloting.

The weather data can be segmented (with overlap) or partitioned (with overlap) according to different “quality” or “service” levels. According to the invention, third-party data sources (with respect to the regulatory meteorology) can be taken into account in meteorological synthesis of the method according to the invention. For example, a data source indicating the presence of migratory birds in a given sector can help to improve the “meteorological” understanding in the broad sense. A certain number of data, of strategic and informative type, different from the regulatory data deriving from the flight file, can be refreshed and consulted in flight, originating from sensors internal to the aircraft or accessible by download from the ground via communication means (satellite or other). In one embodiment, one or more data of non-regulatory type can be requalified as data of a level equivalent to that of the regulatory data.

Capitalizing on sources of “open world” type is now also possible. Currently, the FMS DATALINK makes it possible, for example, to transmit information of temperature & wind type: such information is interesting but a system increasingly relying on open sources can allow for the transmission of more recent and/or more comprehensive information. In particular, in one embodiment, the information on weather passed through locally (i.e. actually) by an aircraft (e.g. AirData, Wx Radar, etc.) can be transmitted to the other aircraft close to its area (or those whose trajectory will have one or more points of interception with the trajectory of the aircraft concerned). And this can be done securely, by using one or more block chains and/or smart contracts. Numerous open sources can be used, notably CoCoRaHS (Community Collaborative Rain, Hail & Snow Network) data, data on storms and lightning (lightningmaps.org fr.blitzortung.org), etc.

Validity of the Weather Data and Models

The weather conditions change in space over time, variably depending on the weather phenomena. Jet streams can for example last longer than more fleeting cloudy episodes. The weather data can therefore be associated with data of change (dynamic) and/or of validity (end, start) in terms of space and/or time.

In one embodiment, the data of change and/or of validity associated with the weather data can be attributes of the data, which are determined natively as they are communicated, or else determined after the fact (application of models). In one embodiment, the time-based validity parameters comprise a single date, e.g. end, expiration, expiry, usage limit date. In one embodiment, the validity parameters comprise several dates (e.g. start date and end date, modulo tolerances, etc.) and/or multiple information (e.g. quantified risk, reliability, trust intervals, source notation, etc.). Similarly, the space validity parameters comprise various attributes (e.g. permanent, episodic, transient, etc.) on different space scales (e.g. microcell, cell, area, region, country, continent, hemisphere or flight zones).

In one embodiment, the weather data communicated by the aircrafts or drones are associated with dates or space-based and/or time-based validity intervals, which are stored in the base 210.

In one embodiment, the weather data can be handled by one or more weather models. The models can be one or more models from among the GFS (Global Forecast System) model, the CEPMMT (European centre for medium term weather forecasts) model, the WRF (Weather Research and Forecasting) model, ARPEGE (world) model, the ARPEGE (Action de Recherche Petite Echelle Grande Echelle) model, the AROME (Application of Research to Operations at MEsoscale) model, the CFS (Seasonal Climate Forecast) model. In some embodiments, these models can modify (e.g. add, delete, replace) the time-based and/or space-based validity dates.

In one embodiment, a communication or feedback loop (with the regulator, an ATC or a certified and/or authorized organization) can make it possible to (re)qualify the weather information. For example, the presence of migratory birds alongside a given airport may be “endorsed” by the appropriate regulator.

### “Big Data”

The expression “Big data” denotes the collection and analysis of data, performed on a massive scale. This concept is associated with characteristics of a technical nature which comprise: the volume (e.g. large data collections, even if redundant), the variety (e.g. numerous different sources are used), the velocity (e.g. the data are “fresh” or constantly updated in changing or dynamic environments), attesting to a certain veracity (e.g. the weak signals which are embedded in the noise are not eliminated and can consequently be detected or amplified), to ultimately represent a certain value (for example the usefulness of the technical and/or business viewpoint).

Distributed Registers or Block Chains

According to the definition given by Wikipedia, a block chain or a distributed register (DLT for “Distributed Ledger Technology”) is a distributed database secured by cryptographic techniques. The transactions exchanged are grouped in “blocks” at regular time intervals, securely by cryptography, which form a chain. After having stored the recent transactions, a new block is generated and analyzed. If the block is valid (distributed consensus), the block can be timestamped and added to the block chain. Each block is linked to the preceding one by a hash key. Once added to the block chain, a block can no longer be either modified or deleted, which guarantees the authenticity and the security of the network. The chaining uses hash functions and Merkle trees. A hash tree is made up of a set of independent checksums. The checksums are concatenated according to a tree structure. A hash tree makes it possible to be able to check the integrity of a dataset without necessarily having all the data at the time of verification. The records in a block chain are protected against falsification or modification by the storage nodes: falsifying a block entails falsifying all of the chain, so that the total cost becomes prohibitive and guarantees a level of trust in the non-falsification of the block chain as a whole. The transactions are visible throughout the network (apart from so-called “pruning”).

Time is an important factor for block chains (notions of broadcasting, of propagation, of latency, etc.). The distributed consensus of all of the nodes of the network can take a highly variable time depending on the technologies used. It can be accelerated by using various techniques, notably “sidechains”, which also increase the storage capacities.

In the context of distributed consensus, a block chain can use a (“proof of work”) validation. From the mathematical point of view, a proof of work is “difficult to prove but easy to validate”. The proof validation systems are generally asymmetrical: the computation required as the counterpart of a service request is costly for the applicant but remains easy to check by a third party. Different techniques can be used, notably hashcash or a “client-puzzle”.

The “mining” nodes are entities whose role is to supply the network with computation power, to allow the updating of the decentralized database. These miners can be rewarded by the distribution of cryptographic tokens. Other payment methods (in addition or in place of) provide commissions on the transactions. “Miners” are not always necessary: in the case of the private block chains for example, the participants to the block chain themselves maintain the distributed database.

A block chain can be public or private, or subject to intermediary governances, which can use different barriers to entry (validation by proof of work). A “public” block chain functions without trusted third parties (so-called “trustless” model), generally with a complex proof-of-work validation (e.g. hashcash). A public block chain generally does not define any rule other than that of the code consisting of the protocol and software technology of which it is composed. A “private” block chain comprises nodes that are participants to the consensus which are defined in advance and then authenticated. Its rules of operation can possibly be extrinsic.

The block chains can be or become programmable through the use of “smart contracts”. The smart contracts are computer software or protocols which facilitate, verify and execute the negotiation or the execution of a contract. They aim to emulate or approximate the logic of the contractual clauses (contract law). The smart contracts are not strictly equivalent to contractual agreements. They contribute to making the violation of an agreement costly because they control a good through digital means. They can provide—or not provide—for the intervention of third parties to the contract to follow its execution (for example machines or “oracles” or oracle services. A smart contract is software code which is stored and is executed on/by a block chain and is triggered by external data which allows it to modify other data, in the block chain or elsewhere.

The execution of a smart contract is predictable/foreseeable; at the very least the code and therefore the nature of the computations or tests performed by this code are known. The code of a smart contract is stored on or in the block chain; the execution of the smart contract is performed on the validation of the blocks (the computation resources are distributed, which means that the execution of a smart contract is safe in itself: the code of the smart contract is replicated in several nodes of the architecture implementing the block chain; being deterministic, the results of the different executions must be identical. Consequently, the code and the execution of the code are safe.

As for any computer program or code, different programming languages are available, with different security and regulation models (blanket contract governing other contracts, cascade contracts, etc.). The forms taken by the smart contracts can be various (e.g. services, agents, snippets, scripts, SOA, API, add-ons, plug-ins, extensions, DLC, etc.). The mathematical logic (the decisions taken affecting the data) can be that of conventional, fuzzy, combinatorial, intuitionistic, modal, propositional, partial, para-consistent, or other such logic or a combination of such logics. The software can be coded partly or wholly in hardware form (e.g. FPGA). A smart contract can be wholly or partly open source and/or closed source. In the open source case, the code can be audited or checked by the parties or third parties. A smart contract can combine open source parts (e.g. that can be audited, verified, improved, etc.) with closed parts (proprietary, secret, sensitive, etc.). A closed source can be a binary, possibly obfuscated or hardened. There are various possible cryptographic techniques: symmetric, asymmetric, “post-quantum”, “quantum-safe”, with the use of “Quantum-Key-Distribution”, etc.). A smart contract can be human and/or machine readable.

Embodiments of the invention are described hereinbelow.

In one embodiment, a method implemented by computer for the sharing of weather data is described which comprises steps of: collecting weather data during flights of a plurality of aircraft; receiving data relating to the trajectory of a client aircraft; based on said trajectory, selecting relevant weather data in a shared weather database 210 comprising the collected weather data; in response to a request from the client aircraft, authenticated as one party out of several parties participating in a block chain 100, communicating the weather data selected according to a weather data exchange control mechanism.

A party participating in a block chain can be associated with one or more aircraft (airline), in some cases with no apparatus (ground station). Failing smart contracts, the exchange control mechanism can be implemented in a single software package (for example centralized) or distributed peer-to-peer (e.g. between airplanes).

The weather data can be aggregated, in as much as the measured weather data can be that measured during one or more past flights or of one or more aircraft associated with one or more predefined parties participating in the block chain.

In one embodiment, the method comprises a step of comparing the trajectories of the airplanes which are in flight with the weather data provided (location, values, etc.), i.e. the intersection of the data. In one embodiment, the step of selecting relevant weather data comprises time-based and space-based comparisons, notably the steps of comparing the areas of space associated with the trajectory in time intervals compatible with the validity time intervals associated with the weather data.

In one embodiment, the weather data exchange control mechanism is determined by one or more smart contracts.

A smart contract comprises a computer program stored in (and/or executed by) said block chain (or another associated block chain). The use of smart contracts on the block chain (or on a chain of secondary blocks) guarantees the safe execution of the associated programs, and allows, in certain conditions the auditability of the source code. In one embodiment, one or more smart contracts implement exchange rules according to conditions of FRAND type, i.e. fair, reasonable and non-discriminatory prices.

In some embodiments, the smart contracts are themselves regulated (for example by a regulation authority).

In one embodiment, the method comprises a step of determining a confidence score associated with a predefined party participating in the block chain.

For example, a ground station supplying weather data can participate in the sharing ecosystem, and be continually “scored”.

In one embodiment, the confidence score of an aircraft is determined according to the correlation that exists between the weather data measured by said aircraft on the one hand and the weather data measured by another aircraft on the other hand.

The aircrafts can act as so many “probes” which add, verify, update, confirm or otherwise modify the weather database (object changing by definition). In dense traffic areas, many cross checks are therefore possible. In areas with little coverage, the aircraft in flight supply rare weather information (which is always better than no information at all). Valorization mechanisms can compensate for these aspects, and valorize the supply of data if necessary. It is implicit that the weather data can have different validity intervals in time and/or in space (fleetingness of objects, movement of stormy phenomena, etc.).

In one embodiment, the confidence score CS associated with an aircraft can be reduced (for example in proportion to the deviations observed, or according to a function that may be analytical for example). In variant embodiments, the confidence score can be manipulated algorithmically, i.e. by the application of rules unfolding over time.

Advantageously, this confidence scoring and tracking system, additionally secured through the use of a block chain, makes it possible to reduce or prevent the injection of “malicious” meteorology.

In one embodiment, a confidence score can be accompanied by various other scores, notably intended to reflect a data uploading or downloading excess or deficit, or even the aggregate number of uses of the shared datasets, etc.

In one embodiment, a data communication is associated with a financial transaction.

In one embodiment, the price of the weather data communicated is set and predefined. In one embodiment, the price is variable and determined dynamically, for example through bids or by order book costing.

In one embodiment, the data exchanges are controlled, for example capped, by application of one or more thresholds or threshold bands, notably according to a data uploading/downloading ratio.

In one embodiment, the method further comprises a step of displaying, in the cockpit of an aircraft, one or more confidence scores associated with one or more parties associated with one or more aircraft.

In some embodiments, the origins of certain weather data can be at least partially displayed. In one embodiment, the origin of the information can be indicated (e.g. colour, icon, “community data” text, etc.). This embodiment offers the advantage of allowing the pilot to contextualize the weather information.

In one embodiment, the weather data originate from so-called open sources.

An open source is a source which is not certified (or not regulated). The reliability which emerges from the method according to the invention precisely makes it possible to handle data originating from open sources (which would not have been possible with mechanisms not using reputation management through a block chain).

In particular, ground stations can push weather information.

In one embodiment, the method further comprises the step consisting in an air traffic control authority validating weather data from among the shared weather data.

In one embodiment, the method further comprises one or more machine learning steps conducted on the shared weather data.

In one embodiment, the machine learning is unsupervised, or is applied over different competing machine learning techniques.

In one embodiment, weather data are associated with time-based and/or space-based validity parameters, for example are geolocated and/or timestamped.

In one embodiment, one or more weather models modify said time-based and/or space-based validity parameters, and determine the relevant weather data.

The weather models can determine the weather data which are relevant to (applicable, which have an effect on) the declared (or predicted or simulated or revised) trajectories. For example, the weather data of an area of space adjacent to a flight plan segment can indicate the movement of a stormy phenomenon on the trajectory. The intervention of a weather model therefore allows weather dynamics to be taken into account (if the data do not contain or are not natively associated with this information of change). The term “relevant” can be replaced by the expression “applicable in excess of one or more predefined thresholds”.

In one embodiment, a system for sharing aeronautical data is described which comprises: a block chain 100 maintained by a plurality of predefined parties comprising computation and storage resources, said block chain being configured to execute one or more smart contracts determining the control of the weather data exchanges; a database 210 comprising weather data referenced by the block chain 100; at least one aircraft computer configured to request and/or receive weather data.

In one embodiment, a party participating in the block chain is a drone (unmanned) configured to measure weather data.

In one embodiment, a computer program product is described, said computer program comprising code instructions making it possible to perform one or more of the steps of the method, when said program is run on a computer.

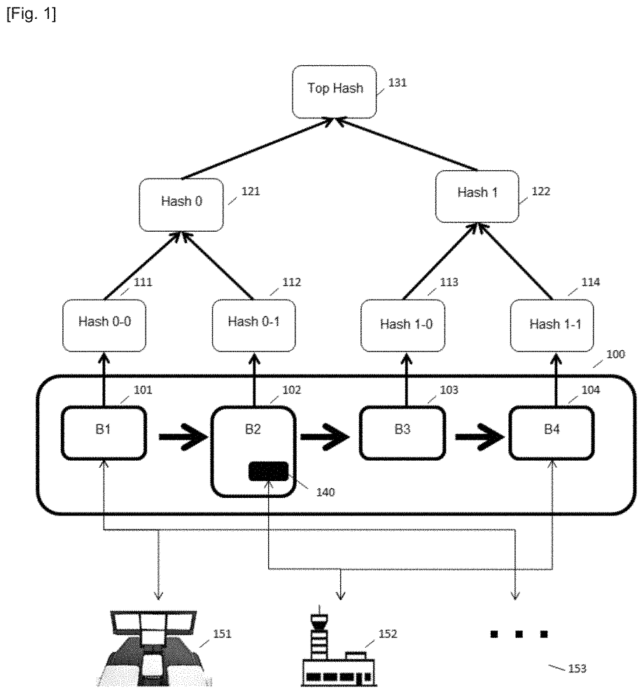

FIG. 1 illustrates the operation of a block chain.

FIG. 1 shows four data blocks B1 to B4 (101, 102, 103, 104). The hash tree consists of a set of interdependent hash values. The leaves of the tree are the hash value of each of the initial data blocks (111, 112, 113, 114). In a Merkle tree (binary), these hash values are then concatenated two by two to be able to compute a new parent hash (121, 122). This continues to the top of the tree where a top hash (131) is obtained. To guarantee the integrity of one block relative to all the data, it is sufficient to have the sibling hash values, the hash values of the uncles and the top hash. Furthermore, only the top hash (131) has to be recovered so as to be sure to guarantee the integrity of all the data represented by the tree. For example, to check the integrity of the block B2, it is sufficient to have recovered the hash 0-0 (its sibling 111), the hash1 (its uncle 122) and the top hash (131).

A data block can comprise one or more codes or programs or smart contracts 140.

In concrete terms, a smart contract 140 can implement one or more mechanisms: (a) access to the data or parts of data:—i) management of access rights and sharings of encryption keys (in the case of an asymmetrical encryption the private key is secret and known only to the user or the public key can be known to a register); hardware encryption mechanisms can be used (TPM or HSM, chip card, etc.); ii) subscription by time unit (daily, weekly, monthly, annual, etc.) and/or by data volume (e.g. by the megabytes of data downloaded); credit or point systems can be used; b) payment; the transactions can be settled in counting units (cryptocash or banknotes, e.g. USD or EUR);

The data blocks (101, 102, 103, 104) are produced then consumed, i.e. accessed, in read and/or write mode, by parties or enterprises (e.g. illustrated by 151, 152, 153).

A party or enterprise or consumer can be the airplane constructor, an assembler, an equipment fitter, a client or an airline, a company supplying weather data, a regulation authority, etc.

A party can be “producer” of data and/or “consumer” of data. A consumer of data can be called “client” or “requester” or “receiver” or “purchaser” hereinbelow. A producer can be called “sender” or “server” or “supplier” or “vendor” hereinbelow. The expression “and/or” underscores the fact that the production and the consumption may be successive or alternative or even simultaneous. Since each party can purchase and/or sell, take a license and/or grant a license, grant or give or share data which are specific to it, it can also access the data shared by the other parties. The pooling of the data makes it possible to create other data, some of which can have market or technical or other value.

As another example of producer/consumer of data, the air traffic control authorities 152 can produce and consume data. The data can concern NOTAM notifications, various warnings, routing statistics or flight plan statistics, etc.

Finally, a wide range of parties 153 can consume or produce useful data: weather data, analysis services (“analytics”), etc.

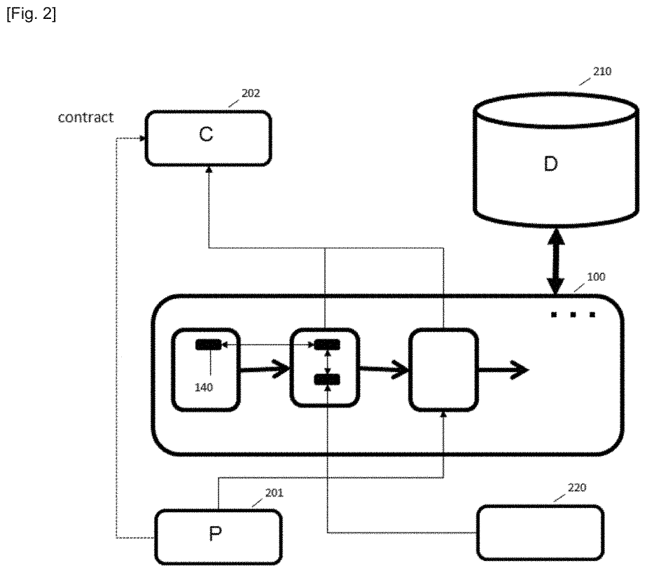

FIG. 2 illustrates an embodiment of the invention.

The illustration makes it possible to appreciate the different layers or levels involved in the methods or systems according to the invention:

a first metadata or block chain layer 100; inheriting the properties inherent to a block chain (e.g. integrity, non-falsifiability, etc.); the block chain 100 is essential, the other levels are optional. The block chain is essential in that it can contain “everything” (here the weather data, the metadata, third-party databases, etc.) but it can be lightened, notably by transferring the non-critical or voluminous data into secondary databases, also in block chain form (“sidechains”, or not, i.e. without the use of block chains;
a second, data layer 210, called or referenced by the block chain 100 (partly or wholly encrypted); these data DB 210 comprise in particular the weather data shared, uploaded and/or downloaded. The weather data comprise the standard weather data (e.g. altitudes, pressures, speeds, QFE/QNH, etc.). These data can be stored in the database 210 according to different formats (.txt, .doc, .rtf, .xml, .json, etc.). The data 210 can also comprise metrics on uploads, downloads, usages, etc., which can in turn determine scores or other quantifications (by means of logic decision circuits, e.g. computers);
a third layer of coordination or of regulation between actors (who in turn act as producer P 201 or consumer C 202, reading and/or writing to the block chain 100. The agreements between participants to the block chain can be written contracts (non technical), or else partially—or wholly—transcribed via typical smart contracts 140;
a fourth layer 220, optional, can regulate the smart contracts (linked contracts, independent contracts, framework contract modifying other contracts downstream, or conversely upstream, multiple feedback loops between contracts, feedforward, etc.). Optionally, this block 220 can represent one or more validators (or “oracles”, which can correspond to an independent human and/or machine validation, i.e. algorithmically encoded).

A large number of embodiments of the invention are possible. A few examples are described hereinbelow.

### Public or Private Chains

In one embodiment, the block chain 100 of weather data is public. It is notably possible to implement a proof-of-work (PoW e.g. hashcash or variant) validation. In one embodiment, the block chain of weather data is private: each participant is previously approved (by contract or agreement 201-202) and technically has keys or authentication means. A validation by “proof-of-stake” (or PoS) is then possible.

Secondary or Derived Block Chains

Additionally or alternatively, one or more secondary block chains (not represented) can be used. For example, a main block chain can contain metadata relating to the weather data (i.e. including the hash values of the data), while a secondary chain can contain the data themselves.

Algorithmic Encoding of the Exchanges

To frame a free and unfalsified competition, limits or other guard rails can be encoded algorithmically. For example, if it is found that there is only a single supplier for a category of weather data, then mechanisms for automatically adjusting the prices or tariffs can be imposed by the smart contracts: “reasonable” prices can be applied, without conditional access (non-discrimination). Independent scoring entities (“oracles”) approved by the participants to the block chain can contribute to the scores and/or to the transaction regulation modes.

Various reward (or compensation or remuneration) mechanisms can be implemented. Different incentive models can also be implemented. In some cases, the mechanisms can be static and predefined. In other cases, these mechanisms can be dynamic. In some embodiments, the mechanisms can tend toward an equality of processing between the participating actors (a priori) or “fair” rewards (assessed and/or adapted a posteriori).

Exchange Regulation

The exchanges can be regulated algorithmically, i.e. clearly, impartially and in a predefined manner, e.g. determination and manipulation of the scores of the participants to the block chain.

In one embodiment, each participant is associated with one or more scores, for example of “trust”. These scores can change over time (e.g. regular updates, after each transaction, etc.). In one embodiment, the scores of a party are summarized in a synthetic score (“rank A”, “rank AA”, etc.) synthesized from a plurality of criteria (comprising the quantification of the quality of the data sent measured for example by their number of uses by the peers, the committed sums spent or received, etc.).

In one embodiment, a node or participant to the block chain is associated with a synthetic score VS (Value Score), which can govern the accesses to the exchanges (as producer and/or consumer of data).

In one embodiment, this score VS can be a function of i) the “value” of the information that it produces VS_PROD and ii) the “value” of the information that it consumes VS_CONS. The value VS can be expressed in the form of a score (figure), of a symbol, of cryptocash value, of real cash (banknote), etc. The score VS can notably be a function of a confidence score CS and/or of a veracity score (see below).

The term “value” designates a quantification made according to predefined criteria, the aim of this quantification being to interpret the absolute and/or relative usefulness of the data shared by the participant. The usefulness can in fact be absolute (some performance data may be rare, or on the contrary public and of zero use), but also relative (data on changes of flight plan levels based on the ATC centres and fuel consumptions can significantly assist in the machine learning methods by multiplying the trajectory envelopes, etc.). The extrinsic quantification of the relative value can be difficult, even impossible, to establish (dependent on the context of use that is uncontrolled and extraneous to the object of the invention), but nevertheless any quantification effort may not be in vain and floor estimations can be established, notably because of the marketplace structure (the market value of a type of data can reflect its usefulness downstream).

In one embodiment, a client or consumer purchases, for an amount VS_MONEY, the right to consume (e.g. credits) to be able subsequently to consume data (which can be useful if it consumes more of it than it produces). Another party to the block chain can transform its VS (Value Score) into real cash (or into cryptocash), e.g. for other, non-inventive uses. Its VS is then reduced by the amount VS_MONEY. The score VS of a party to the block chain is therefore made to change as a function of the attractiveness of the data that that party produces and shares. Different quantification methods, possibly considered in combination, are possible. The criteria can comprise one or more of the elements comprising: number of subscribers, number of downloads and/or uploads of data packets (“datasets”), results of votes or scores attributed by one or more consumers, the volume in gigabytes of shared data, etc.

The values VS_PROD (value of the data produced) and VS_CONS (value of the data consumed) can be computed in various ways, notably by quantity (volume of data) and/or by quality (e.g. criticality of the computer or of the embedded function), as a relative value resulting from an offer/bid confrontation (e.g. quotation, price consensus order book, proposal, counter-bid, acceptance, refusal, negotiation, etc.), taking into account the history of use, the price at a given instant based on predefined parameters, taking into account the minimum and maximum prices, as determined for example by a logic decision circuit emulating FRAND (fair, reasonable and non-discriminatory) access conditions, etc. The values or computation modalities can be inscribed or determined by a smart contract, which can be bipartite (agreement between two actors) or multipartite (agreement between N suppliers and M consumers).

In one embodiment, the block chain can determine (for example in real time) the score of a party participating to the block chain. This score being inscribed in the block chain inherits its properties (non-falsifiable value, certain history).

In other embodiments, various analysis or meta-analysis services can be determined: contributor history and awards, computation of risks of injection of false data (i.e. simply erroneous data) or malicious data (intentionally false to weaken or falsify the computations made by the third parties, etc.). Since the block chain is transparent with respect to at least certain data (descriptive metadata, transaction histories, etc.), a possibly malicious party will rapidly be determined as such and ejected from the kernel of trust between authenticated parties. On the other hand, the transparency of the system whose governance is at least partly auditable encourages the participants to abandon a certain sovereignty with respect to the data, in consideration of access to third-party data and/or financial compensation.

When a producer publishes one or more weather data sets in a base 210, by publishing the corresponding hash values in the block chain 100, the corresponding metadata are added in a block, which is timestamped. The block makes it possible to identify the source (successful authentication) and provides a guarantee as to the integrity of the data filed (hash values). When a consumer receives a weather data set from the base 210 associated with the block chain, the score of the producer is re-evaluated (e.g. addition of the determined sum if the block is validated, removal of the sum if the data set is corrupted or false or empty or otherwise invalid) together with its own score (with a value for example that is the inverse of that credited to the producer, but various weightings can be applied). This transaction comprising these credit/debit entries, identification data, etc., are written into the block chain. This way, the parties appear either as data supply surplus or deficit. It may be that ongoing or intermittent deficit situations are acceptable (e.g. can be compensated by funds flow): the main thing is that the arbitrages are transparent and safe, i.e. traceable and non-falsifiable.

Embodiments with Smart Contracts

In one embodiment, the collaborative sharing module can be based on one or more “smart contracts”, the contract making it possible for example to ensure quality of processing (in value terms) between the participants. The data are shared on a block chain in order to ensure the timestamping and immutability thereof.

In one embodiment, all the data of the blocks are written in clear (e.g. the access rights are protected). In one embodiment, a part of the data are written in clear (some information is legible to all the world, other information of higher added value is protected for example by encryption). In one embodiment, the data of the blocks are encrypted (e.g. symmetrical, asymmetrical, etc.). In some cases, the data of the blocks are masked in addition to being encrypted (the existence of the data is hidden, which provides an additional protection).

In one embodiment, the data are stored in one or more shared databases, wholly or partly encrypted, after their integrity and the authenticity of the producer have been verified.

In one embodiment, the validation of the data produced is provided by distributed consensus (e.g. use validated with a “relevance” score by multiple consumers, measurement and tracking of the rate of use, etc.) and/or by validation of a peer participating in the block chain that is recognized as reliable in the chain (technical qualification or of administrative nature).

In one embodiment, some information (like the format and/or the summary of the content of the encrypted block) are left in clear in a storage space (in the chain or outside of the chain), in order for an interested consumer to be able to know if the block is of interest or not.

In one embodiment, the use that a consumer wants to make of the data of a block is governed (directly or indirectly via rules) by a smart contract. In one embodiment, a smart contract can read block data in clear and trigger one or more operations, for example if the client or applicant or consumer is a valid subscriber to the type of data of the block considered or if predefined conditions are satisfied.

In some embodiments, the rights to the block data can be conditional on contribution criteria (notably “upload/download” or “seed/leech” ratio).

In one embodiment, the access to the data or the rights to these data can be governed conditionally (for example if the balance of the client or Value Score is positive).

If necessary, if conditional access is granted (or if the predefined conditions are satisfied), the smart contract executed can send a data recovery transaction or request, which transaction will be inserted (among several others) in a new block. If the distributed consensus confirms the block comprising the transaction, an encryption key allowing the desired data to be read can be sent to the client; who will be able to read and use the desired data.

Example of Implementation of a Smart Contract

In one embodiment, a supplier fills a database with new weather data. A “provision” smart contract detects the new data and stores the metadata in a block chain (e.g. identification, date, issuer, score, hash of the content of the data, etc.). The data are made available for sale or free of charge (auctioning mechanisms, first come-first served, license DRM mechanism specifying the number of uses, etc.). The price of the thing can be determined, according to various mechanisms (e.g. calculation of value intrinsic to the data for example according to one or more pre-established models, calculation of the value by creation of a market, e.g. quotation and order book, auctions, reverse auctions, etc.). If an agreement on the thing and on the price is found between the block chain (via a smart contract) and a client, then a transaction can be performed (data against data; data against money payment, e.g. banknote, private, accounting units, credits internal to the block chain). A “consumption” smart contract can then be triggered, for example checking various conditions or criteria (e.g. eligibility, score of the purchaser, quantified reputation, access rights, balance, etc.). A smart contract for “provision” of the data can then be triggered and communicate the purchased or licensed data to the client. For example, the information from one or more data blocks (e.g. addresses, encryption key, hash values of the contents of the data, etc.). The client, once in possession of the desired data, can use them (for example technically, e.g. to improve statistics, enrich or feed machine learning systems). The usages of the data can, in addition to the technical protection measures, be framed legally (by contract); for example, the client can have the contractual obligation to destroy the copies of the data that it has after the expiry of a certain date; the client may be prohibited by contract from broadcasting the data accessed, etc.).

In a variant embodiment, a plurality of suppliers share data and store the hash values of the data, and information relating to the format of the data, in one or more block chains. After a transaction has been carried out, one or more smart contracts check the value “score” of the purchaser, indicate to it the position of the data in the shared database, and the data decryption keys.

In a variant embodiment, one or more contracts use escrow account or fiduciary deposit (“escrow payment”) or other such mechanisms. In particular, the data can be re-encrypted, etc.

Direct Embodiment, without Smart Contracts

In a variant embodiment, the producers and/or consumers can dispense with smart contracts, by reading and/or writing (directly) in the block chain. For example, a producer can receive a purchase order from a consumer and, if the transaction is completed, can directly communicate to the consumer. This way, the block chain does not contain the actual data but only the description of the data. This embodiment is advantageous in that the data replicated in the block chain are significantly less voluminous.

Other embodiments are described hereinbelow.

Subscription(s)

In one embodiment, an aircraft can, for example by turns, publish the information intended for the other members of the network or else “subscribe” to the network, for example via a smart contract, and receive the information concerning it automatically. For example, an airplane can share its weather information (for example non-regulatory, or the conditions passed through locally), safely and fully, with other aircraft (belonging to other airlines, specifically). The subscription modes can comprise push and/or pull, deregistration, and other such modes.

Embodiments with External Validation

In one embodiment, an intermediary is added: a data validator (not represented). In a first step, of production, a source decides to publish data in the block chain (directly or indirectly via the base 210). The data are sent with an identifier (which makes it possible to identify the source sending the data) and a summary of the content (e.g. parameters, units, quantity, format, etc.), as well as the date of the data (e.g. creation, validity, etc.). This set forms a “block” to be validated. The validation subsystem receives the data. The validation is made either by consensus or by an external and “trusted” “validator”: Other suppliers or users verify the integrity of the data (and, optionally, the authenticity of the issuer). That can give rise to reward (in VS) for the node or nodes having participated in the validation. It can be the consumer which checks the integrity of the block (hash). In one embodiment, the consumer can “score” (unilaterally) the attractiveness of the block received (its interest estimated for and by itself). In one embodiment, the score is given by the consumer. In one embodiment, the score is calculated by counting the number of downloads of the data set concerned and/or by the number of interested consumers or actual purchasers/licensees. If the data are declared to be invalid then the block chain is updated with a lowering of the VS_PROD by a certain amount for the producer, and an increase in the VS_PROD for that which detected the anomaly. In another embodiment, if the data are considered to be valid/complete then a new block is created, which will contain the link to the data (e.g. addresses, keys), and an increase of VS_PROD by a certain amount for the validating node or party.

Embodiments with Internal Validation

In some embodiments, the validating third party is internalized: the verifications are made directly and automatically by one or more smart contracts. On each new entry in the base (and block write attempt), one or more smart contracts can execute various tasks, in particular a) verifying whether the producer is declared (if it is a party to the consortium or block chain), b) modifying the score VS of the source, c) scoring or assessing the data entered (directly or indirectly), possibly d) directly performing functional verification on the data (for example, data from an aircraft of model X can be correlated/cross-referenced with other sources of information on the aircraft (e.g. public or private company sources, air traffic control) issued in real time and corresponding to the state of the aircraft (e.g. time of take-off, current status, e.g. in flight, on the ground, cruising, current position, etc.).

In order to consume data, a consumer subscribes or declares an interest in recovering data (e.g. purchase order directly on the block chain or by a smart contract). The smart contract concerned can verify whether the purchaser has a sufficient balance (VS) to download the data. In a variant embodiment, the block purchased is made available to one or more human and/or machine validators which perform this verification. If the transaction is valid, the data set (for example encrypted) is transmitted to the purchaser, which can for example have the option to check its integrity (hash value recovered in the block chain). If the data set is determined or deemed to be valid, decryption keys (stored in the block chain) are recovered by the smart contract and transmitted to the purchaser. The transaction is then entered in the block chain by the smart contract. In one embodiment, compensation and/or evaluation and/or reward and/or validation mechanisms can be implemented if the data are determined to be valid (scoring and/or reputation mechanism to identify or reward the issuers of data that are the most “useful” (concept relating to one or more objectives that can be objectivized and internalized)). The requesting consumer, i.e. initiator of the transaction, can for example import the data obtained and cross reference or integrate them with existing data in order to perform a process of “Big Data” type by artificial intelligence techniques (notably machine learning).

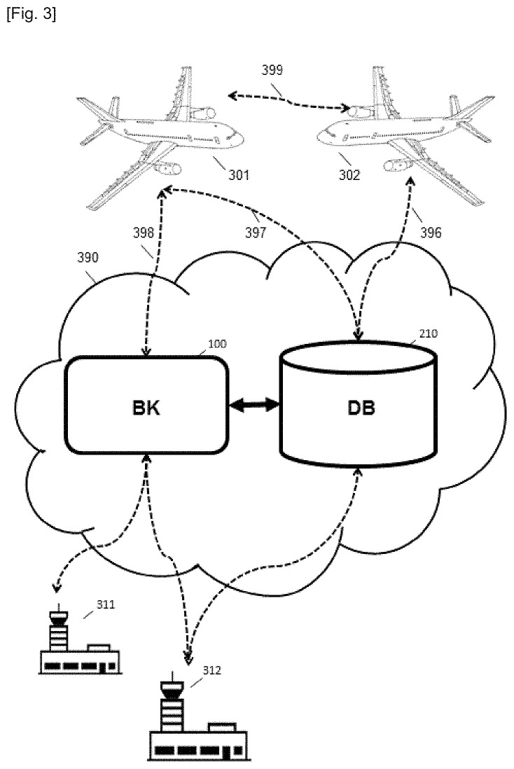

FIG. 3 illustrates an exemplary embodiment of the invention.

In one embodiment, the system according the invention comprises a system (in hardware and/or software form) for the sharing of weather information between different producers (or suppliers) and/or consumers (or clients).

In one embodiment, the block chain 100 (“BK” or “distributed ledger”) is distinct from the database 210 (“DB” or database, e.g. SQL, Oracle, etc.). It may in fact be advantageous to store the weather information as such in a dedicated database (or a “sidechain”) 210 on the one hand, and the metadata or the transactions in the block chain 100 on the other hand (e.g. actors, identifiers, transactions, VS, CS and other values). The data stored in the block chain 100 are in fact replicated multiple times, and it is generally inefficient to store weather data whose obsolescence can be quick.

In one embodiment, the communications between aircraft are exclusively indirect, e.g. pass via the block chain 100. In one embodiment, the communications between aircraft are partly direct 399, and partly indirect (396, 397). In one embodiment, the implementation is local (i.e. embedded in the aircraft and exchanges can be done peer-to-peer 399). In one embodiment, the implementation is at least partly realized by remote access (e.g. system hosted in the Cloud 390 and accessible from multiple client platforms 397, 398, e.g. EFB, web application on the ground, etc.). In one embodiment, the implementation is a local/remote hybrid (e.g. the peer-to-peer communication capabilities are implemented by cloud computing resources).

In one embodiment, each aircraft can by turns share the information with the other members of the network, or else “subscriber to the network” and receive the information concerning it automatically.

In one embodiment, each member of the network (of the block chain) is assigned a “Confidence Score” (acronym CS) which corresponds to the quality of the information that it sends, this score being made to change according to the quality of the predictions/information that the source sends to the network. The block chain contains, at any instant (modulo the update propagation time), the CS score associated with each actor of the network. When the score of an actor is updated, the block chain is too (the use of the block chain makes it possible to have this information distributed on several nodes and therefore render it immutable and secure as well as having a certain history). When a producer P (e.g. 301) sends local (and/or remote) weather information, and one or more identifiers, this information is added to its CS score.

Sending of Weather Information (“Producer” Mode)

A source, for example a ground station 301, decides to share weather information with its sharing network. The weather data are sent with an identifier or after authentication. The data can optionally be verified as the background and/or form, for example by an embedded module or a ground module 311 or 312 (e.g. verification of the integrity of the data in terms of format, etc.). If the data are declared invalid, then the block chain 100 is updated with a lowering of the CS (by a certain predefined amount) for the source concerned. This background/form verification can optionally be performed in or by a smart contract (parallel executions of the distributed copies, guaranteeing the safe execution of the auditable code). If the data are considered complete, then a new entry can be made in the database DB 210, which will contain the weather data and information relating to the data source 301, the block number, version number, etc. On each new entry in the database DB 210, the method according to the invention comprises a step which consists in comparing the weather data supplied (location, values, etc.) with the trajectory of the airplanes which are in flight. If no airplane currently in flight has a trajectory which intercepts the location of this weather information around a certain threshold then no action is taken. If, on the contrary, one of the airplanes in flight has a trajectory which passes at a “close” distance (i.e. based on threshold intolerances) from this meteorological point, then verifications can be made. Among these verifications, it is possible to: a) correlate the information received with the data already present in the base or else those sent by the ATC/AOC, etc., and estimate whether they are “close” or not; b) qualify the information received according to the quantity of data available in that area, if the data are supplied by areas or the weather information is rare (e.g. old latest update, few weather stations in the current area, etc.). Based on the determined verifications and the confidence score, it is possible to determine one or more actions.

In one embodiment, once the flight is ended or the aircraft has passed the geographic area linked with the information supplied, “confirmation” or “denial” information can be sent by the airplane in order to qualify the quality of the information. If the information is true or correct (modulo tolerances according to one or more thresholds or predefined threshold ranges), then the source concerned can have its confidence score CS updated and increased. On the contrary, if the information is too far from that encountered in real life, the confidence score CS can be reduced (for example in proportion to the deviations observed, or according to a function, for example an analytical function). Advantageously, this system makes it possible to reduce or prevent the injection of “malicious” meteorology.

In one embodiment, the block chain updates the CS scores of the different sources, for example upon the addition of a new block.

In one embodiment, the method comprises a reward mechanism. For example, at certain predefined time instants, the best contributors can be determined (according to predefined rules or criteria). For example, information supplied for an area associated with little information can be valued, by contrast with data supplied for highly frequented areas. Information making it possible to avoid dangerous weather phenomena can, ex post, justify bonuses or gratuities or other improvements of the confidence score. Other mechanisms deriving from e-reputation management (sometimes called web-reputation, cyber-reputation, digital reputation) can be used (scoring agency, watch, specific search engine, RSS aggregators, insurance, etc.).

Reception of Weather Information (“Consumer” Mode)

In one embodiment, the method according to the invention comprises a step in which an aircraft declares its current or future (planned) trajectory. The geolocated weather information shared and stored in the database 210 are then considered and the events that will concern said aircraft are determined. The relevant information is then communicated to the airplane. The latter can take this data into account, or not (if they are more accurate and/or more recent). Some of these data can be at least partially displayed. In one embodiment, the origin of the information can be indicated (e.g. colour, icon, “community data” text, etc.), which can assist the pilot in contextually interpreting or synthesizing the meteorology. For example, the details of the data sources can be indicated or be accessible.

In one embodiment, one or more aircraft transmit the weather data actually passed through and measured. The real information can then be used to evaluate the information obtained from collaborative sharing.

In other words, it is possible to determine the veracity of the information communicated by a given source. Depending on the embodiments, the veracity can be binary (true or false), expressed according to discrete graduations (“rather true”, “rather false”, etc.) or quantified continuously (score between 0 and 100).

In one embodiment, based on the difference between the measured real data and the shared communicated data, a score can be assigned to or associated with these communicated or shared data and/or with the CS score associated with the source of the data. Indirectly, the assignment of a score to the declared data can trigger a mechanism (function) or complex rules contained in a smart contract which will be able to modify the CS score of the source, for example according to the veracity score obtained by the data. The CS score of a source can therefore be the result of a function (analytical) or else of an algorithm (execution of a program in time). In one embodiment, a smart contract can trigger a new transaction in the block chain (updating of the CS score of the data source).

In one embodiment, the information used to establish the veracity of the weather data can originate from an “Oracle” or from an Oracle service, provided by a third party. The third party can notably comprise an air traffic control or air navigation entity (in other words, it can have a weather validation loop shared by this type of organization before the dissemination of the information).

Diversity of Oracles

In one embodiment, an Oracle or Oracle service aims to provide or guarantee that the weather information is “correct”, i.e. sufficiently close to reality. In one embodiment, an Oracle is a program or software (satellite analysis, etc.). In one embodiment, an Oracle is a secured program, for example a smart contract. In one embodiment, a smart contract is in reality the result of an assembly of a plurality of smart contracts (the smart contracts may be nested in one another, e.g. blanket contract, rider, etc.).

In one embodiment, one or more Oracles and/or parties participating in the block chain can be drones (unmanned) which fly the planned trajectories of the aircraft. In some embodiments, airships or stationary or quasi-stationary balloons can be used to mesh the space and corroborate the data communications, in addition to what the airplanes explore themselves.

In one embodiment, an Oracle can be (the fact of) an institution (a national weather office, e.g. Météo France, a “National Weather Service”, etc.).

In one embodiment, a new block (added to the block chain) can comprise one or more transactions. In one embodiment, a transaction can comprise one or more values taken from among the values comprising: a) the hash value of the preceding block, b) a timestamp value, c) the identification of the source, d) the veracity score of the shared weather information, e) the pointer or the identification of the weather data in the database 210, f) the increment or the decrement with respect to the confidence score CS (for example +10 or −10 based on the downloaded information veracity score), g) the increment or the decrement with respect to a VS score to be added (for example based on the quality of the data).

In one embodiment of the invention, the method according to the invention can comprise different data integrity verification steps. For example, the data format can be verified (semantics, etc.). The consistency of the source with respect to information previously sent (for example for a ground station, therefore one that is theoretically immobile, it is possible to determine whether the geolocation information is consistent over time, whether the values are plausible, i.e. within realistic intervals, etc.

In one embodiment of the invention, the method according to the invention can comprise different weather data validity verification steps. In one embodiment, the database 210 can be regularly “cleaned” by deleting the obsolete data (e.g. outdated data). However, it may be advantageous to preserve history data for learning purposes: consequently, the obsolete data marked as such may not be taken into account by the weather models possibly invoked but be for statistical or learning purposes. To this end, the obsolete or outdated data can be moved into an archive database (not represented).

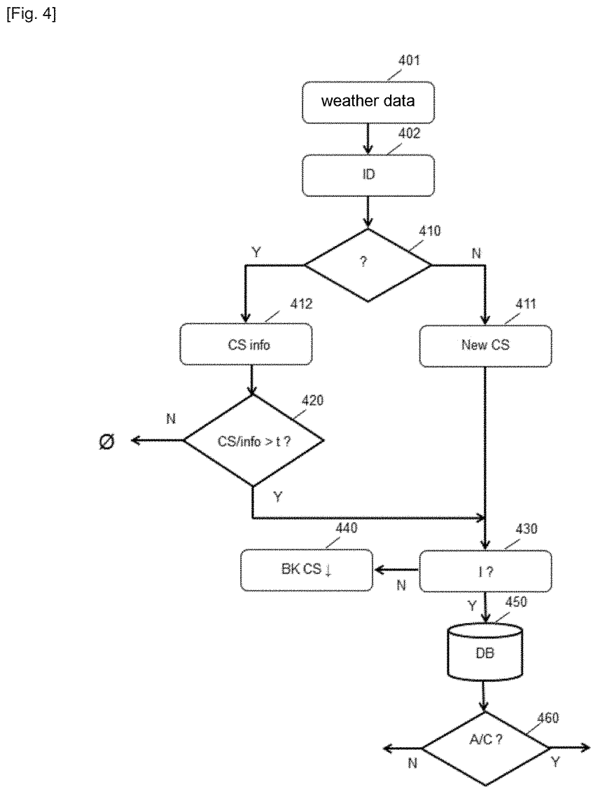

FIG. 4 illustrates examples of steps according to an embodiment of the invention.

In one embodiment, the method comprises a step 401 in which a data source transmits new weather data to the system (these data are rich, i.e. can be associated directly or indirectly with one or more validity intervals, trust ratio intervals, etc.). The identity of the source is verified in step 402. In the step 410, whether or not the source is known is tested. If necessary, the information 412 relating to the source of the weather data is extracted from the block chain 100. By default, the data source is considered to be a new data source 411; the latter then begins with a default CS parameter. If the data source is known, the CS/info ratio is tested in the step 420 to see if it is favourable, for example if it is greater than a predefined threshold. If necessary, optionally, the integrity of the data is verified in the step 430. If the data are complete, in the step 450, the weather data are added in the database 210. By default, the CS parameter of the data source is reduced in the step 440. Finally, the method can comprise a step 460 consisting in determining whether the weather data concern one or more aircraft, for example within a time interval compatible with the validity time interval of the weather data. In other words, in the step 460, a determination may be made as to the intersection between the present and future trajectories of the aircraft on the one hand, and the present and short term future of the weather phenomena on the other hand. Some weather phenomena can remain for several days but most of the events remain for a few hours or less.

If the data concern an A/C aircraft currently flying (e.g. by geographic cross-checking modulo a distance or tolerance), then the method can comprise a step consisting in assigning a score to the weather information, for example based on the latest known update on the area concerned, of the CS parameter of the source, etc. Consequently, one or more aircraft with flight plans that include passage through the geographic zone affected by the data can be identified. The data are then transmitted to the identified aircraft. Different displays are then possible via the human-machine interfaces (e.g. different symbologies, use of augmented reality and/or virtual reality). In a particular embodiment, once the aircraft have passed through the annotated areas, it is possible for said aircraft to qualify the veracity of the weather information received, a posteriori. The qualification can be binary (true, false) or according to discrete qualifications (e.g. modulations, grades, etc.). It is then possible to update the CS parameters of the different data sources.

Software and/or Hardware Implementation

The present invention can be implemented from hardware and/or software elements. It can be available as computer program product on a computer-readable medium. The computer can be a rack or a tablet or an EFB (electronic flight bag) or a software part included in the FMS (flight management system), etc. The medium can be electronic, magnetic, optical or electromagnetic.

Materially, the embodiments of the invention can be realized by computer. For example, a distributed architecture of “cloud computing” type. Peer-to-peer servers, entirely or partially distributed (existence of centres) can interact. A block chain relies on a decentralized architecture, which can be more or less distributed. A block chain implementation does not form an obstacle to the existence of one or more prioritized nodes, for private cloud or private block chain cases. Accesses can be multiplatform (e.g. from EFB, WebApp, ground access, etc).

In one embodiment, an aircraft is equipped with a module for the communication and collaborative sharing of data obtained from computers embedded in the aircraft. This hardware module can be associated with various users (consumers) and/or suppliers (producers) of data. The avionics equipment can interact (bilateral communication) with non-avionics equipment. In some cases, the communications can be unilateral (from avionics to non-avionics, but not the inverse, i.e. to avoid the injection of erroneous or malicious data from the open world to the certified avionics world). Flight management systems FMS can be networked together, also with EFBs.

1. A method implemented by computer for the sharing of weather data, comprising the steps of:
collecting weather data during flights of a plurality of aircraft;
receiving data relating to the trajectory of a client aircraft;
based on said trajectory, selecting relevant weather data in a shared weather database 210 comprising the collected weather data;
in response to a request from the client aircraft, authenticated as one party out of several parties participating in a block chain 100, communicating weather data selected according to a weather data exchange control mechanism.

2. The method according to claim 1, the weather data exchange control mechanism being determined by one or more smart contracts.

3. The method according to claim 1, comprising a step of determining a confidence score associated with a predefined party participating in the block chain.

4. The method according to claim 3, the confidence score of an aircraft being determined according to the correlation that exists between the weather data measured by said aircraft on the one hand and the weather data measured by another aircraft on the other hand.

5. The method according to claim 1, a data communication being associated with a financial transaction.

6. The method according to claim 1, further comprising a step of displaying, in the cockpit of an aircraft, one or more confidence scores associated with one or more parties associated with one or more aircraft.

7. The method according to claim 1, weather data originating from so-called open sources.

8. The method according to claim 1, further comprising the step of having an air navigation control authority validate weather data from among the shared weather data.

9. The method according to claim 1, further comprising one or more machine learning steps conducted on the shared weather data.

10. The method according to claim 9, the machine learning being unsupervised, or being applied to different competing machine learning techniques.

11. The method according to claim 1, weather data being associated with time-based and/or space-based validity parameters, for example being geolocated and timestamped.

12. The method according to claim 11, one or more weather models modifying said time-based and/or space-based validity parameters, and determining the relevant weather data.

13. A system for sharing aeronautical data comprising:
a block chain 100 maintained by a plurality of predefined parties comprising computation and storage resources, said block chain being configured to execute one or more smart contracts determining the control of the weather data exchanges;
a database 210 comprising weather data referenced by the block chain 100;
at least one aircraft computer configured to request and/or receive weather data.

14. The system according to claim 13, a party participating in the block chain being an unmanned drone configured to measure weather data.

15. A computer program product, said computer program comprising code instructions making it possible to perform the steps of the method according to claim 1, when said program is run on a computer.
